(19) United States
(12) Patent Application Publication
(10) Pub. No.: US 2025/0348330 A1
(43) Pub. Date: Nov. 13, 2025

(54) INFORMATION PROCESSING APPARATUS AND INFORMATION PROCESSING METHOD

(71) Applicant: Fujitsu Limited, Kawasaki-shi (JP)

(72) Inventor: Toshiyuki ICHIBA, Kawasaki (JP)

(73) Assignee: Fujitsu Limited, Kawasaki-shi (JP)

(21) Appl. No.: 19/186,802

(22) Filed: Apr. 23, 2025

(30) Foreign Application Priority Data
May 8, 2024 (JP) 2024-076183

(51) Int. Cl. G06F 9/445

(52) U.S. Cl. CPC G06F 9/44505

(57) ABSTRACT

An information processing apparatus that generates an operation configuration including functional units to be used, a connection path between the functional units, and an output path of an operation result, for a reduction operation, based on a plurality of pieces of operation input data including sets of two pieces of data, the information processing apparatus comprising, a memory, and a processor coupled to the memory and configured to, generate an initial operation configuration based on a loop unrolling factor that is a number of the functional units that perform the predetermined operation with the operation input data as a direct input, and generate a first operation configuration by adding an output path of an operation result for a different degree of parallelism in a case where the predetermined operation is repeated with a predetermined degree of parallelism to the generated initial operation configuration.

### CROSS-REFERENCE TO RELATED APPLICATIONS

This application is based upon and claims the benefit of priority of the prior Japanese Patent Application No. 2024-076183, filed on May 8, 2024, the entire contents of which are incorporated herein by reference.

### FIELD

The embodiments discussed herein are related to an information processing apparatus and an information processing method.

### BACKGROUND

Conventionally, a coarse-grained reconfigurable architecture (CGRA) is known as one of data processing devices from the viewpoint of improving the efficiency of data processing and improving the efficiency of power consumed by the device along with the data processing. The CGRA is a processor having a structure in which operation elements called processing elements (PE) including a functional unit, a register, and the like are arranged in a two-dimensional array. The CGRA can reconfigure operation content executed by the PEs during operation and a connection between the PEs.

The program using the CGRA is executed as follows. The program to be executed is converted into a data flow graph (DFG) using a compiler. Next, the operation content executed by each PE and the connection between the PEs are determined according to the configuration of each PE of the CGRA based on the DFG. This determination of the operation content and the connection between the PEs is called mapping. Thereafter, data is input to the CGRA for which mapping is completed, and the GCRA performs operation using the input data.

Here, the description will focus on the reduction operation using the CGRA. The reduction operation described herein is an operation including one type of binary operator that is associative and commutative. The type of operation includes addition, subtraction, multiplication, and division, a maximum value, a minimum value, and the like. For example, the reduction operation of addition is an operation of obtaining a sum of a large number of variables included in the array.

Optimization of the DFG includes tree-height reduction, loop unrolling, and the like. The tree-height reduction is a method in which a DFG is regarded as a tree, and the height of the tree is minimized based on the commutative and associative laws of operators. By performing the tree-height reduction, parallelism of operations is increased and the speed is increased. The loop unrolling is a compiler optimization method and is a method of arranging a designated number of processes in a loop. In the loop unrolling, CPUs corresponding to the number of arranged processes can be used in parallel, and the effect of the tree-height reduction can be enhanced.

For example, in a case of A(2×j+i)+B(2×j+i), if j takes values of 0 and 1, a case will be considered in which a reduction operation is executed in which i takes values of 0 and 1 for each value of j and all are added. In this case, a loop occurs with respect to j and i in the calculation. Here, the description will focus on the loop for i.

Focusing on one variable, the number of times a loop is repeated is referred to as a loop count. Then, in the DFG, determining how many loops of the focused variable are executed in parallel and allocating the corresponding PEs is referred to as a loop unrolling factor.

The loop count of i is two. If the loop related to i is simply converted into a DGF, it takes three cycles to calculate Z(0)=A(0)+B(0). In addition, it takes five cycles to calculate Z(1)=A(1)+B(1)+A(2)+B(2). On the other hand, in a case where loop unrolling is performed on the loop related to i into two pieces of A(2×j)+B(2×j) and A(2×j+1)+B(2×j+1), Z(0) is calculated in two cycles, and Z(1) is calculated in three cycles.

Note that, as a method of allocating a loop that can be vectorized to a PE, a technique of determining the number of PEs to be used for execution of a loop body, reconfiguring a plurality of PEs to one or more fused PEs based on a determination result, and performing allocation has been proposed.
Patent Literature 1: U.S. Patent Application Publication No. 2020/0012618

However, in a case where the loop count of the reduction operation is variable according to the numerical value determined at the time of execution of the input data or the like, the number of PEs used for the reduction operation is not determined until the input of the numerical value determined at the time of execution is received. Here, in a case the loop count is made as large as possible within a range allowed by the resource of the CGRA, the effect of the DFG optimization can be further improved. On the other hand, in a case where too many PEs are reserved for allocating the DFG, there may be many PEs that are not used. Therefore, it is difficult to generate an appropriate DFG at the time of compilation, and it is difficult to improve the utilization efficiency of the PEs in the CGRA.

In addition, in the technology of determining the number of PEs to be used for execution of the loop body and reconstructing the plurality of PEs into one or more fused PEs, the number of PEs to be used is not reduced at the time of compilation, and there is a possibility that there are unnecessary PEs that are not used.

The disclosed technology has been made in view of the above, and an object thereof is to provide an information processing apparatus and an information processing method capable of improving utilization efficiency of calculation resources.

### SUMMARY

According to an aspect of an embodiment, an information processing apparatus generates an operation configuration including functional units to be used, a connection path between the functional units, and an output path of an operation result, for a reduction operation in which a predetermined operation is repeatedly performed on two pieces of data to obtain the operation result based on a plurality of pieces of operation input data including sets of two pieces of data. The information processing apparatus includes, a memory, and a processor coupled to the memory and configured to, generate an initial operation configuration based on a loop unrolling factor that is a number of the functional units that perform the predetermined operation with the operation input data as a direct input, and generate a first operation configuration by adding an output path of an operation result for a different degree of parallelism in a case where the predetermined operation is repeated with a predetermined degree of parallelism to the generated initial operation configuration.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a hardware configuration diagram of an arithmetic device equipped with a CGRA;

FIG. 2 is a hardware configuration diagram of the CGRA;

FIG. 3 is a block diagram of a DFG generation device according to a first embodiment;

FIG. 4 is a diagram illustrating an example of a code having a reduction operation and a loop;

FIG. 5 is a diagram illustrating an initial DFG in a case where a loop unrolling factor is four;

FIG. 6 is a diagram illustrating addition of an output in a case where the loop unrolling factor is four and a loops count is two;

FIG. 7 is a diagram illustrating addition of an output in a case where the loop unrolling factor is four and the loops count is three;

FIG. 8 is a diagram illustrating an initial DFG in a case where the loop unrolling factor is eight;

FIG. 9 is a diagram illustrating a completed DFG in a case where the loop unrolling factor is eight;

FIG. 10 is a flowchart of a DFG generation process according to the first embodiment;

FIG. 11 is a flowchart of an output addition process of the DFG;

FIG. 12 is a block diagram of a DFG generation device according to a second embodiment;

FIG. 13 is a diagram illustrating an example of a hash table;

FIG. 14 is a diagram illustrating a DFG obtained by integrating outputs in a case where the loop unrolling factor is eight; and

FIG. 15 is a flowchart of a DFG generation process according to the second embodiment.

### DESCRIPTION OF EMBODIMENTS

Preferred embodiments of the present invention will be explained with reference to accompanying drawings. Note that the information processing apparatus and the information processing method disclosed in the present application are not limited by the following embodiments.

### (a) First Embodiment

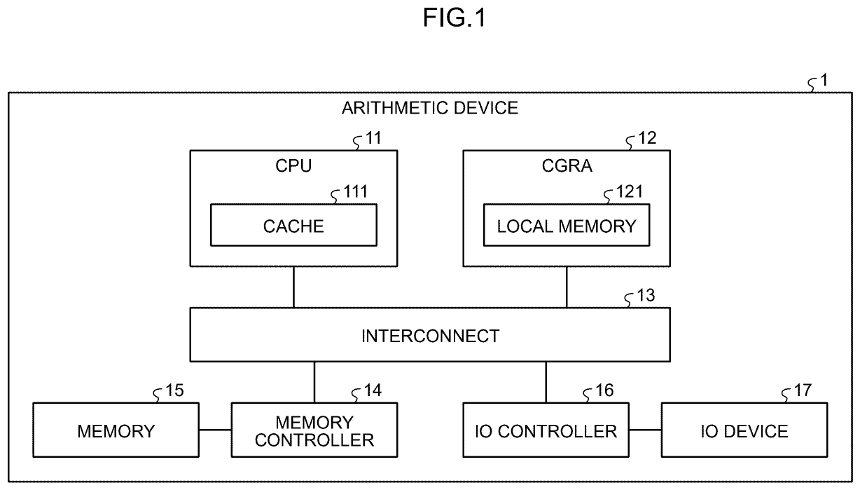

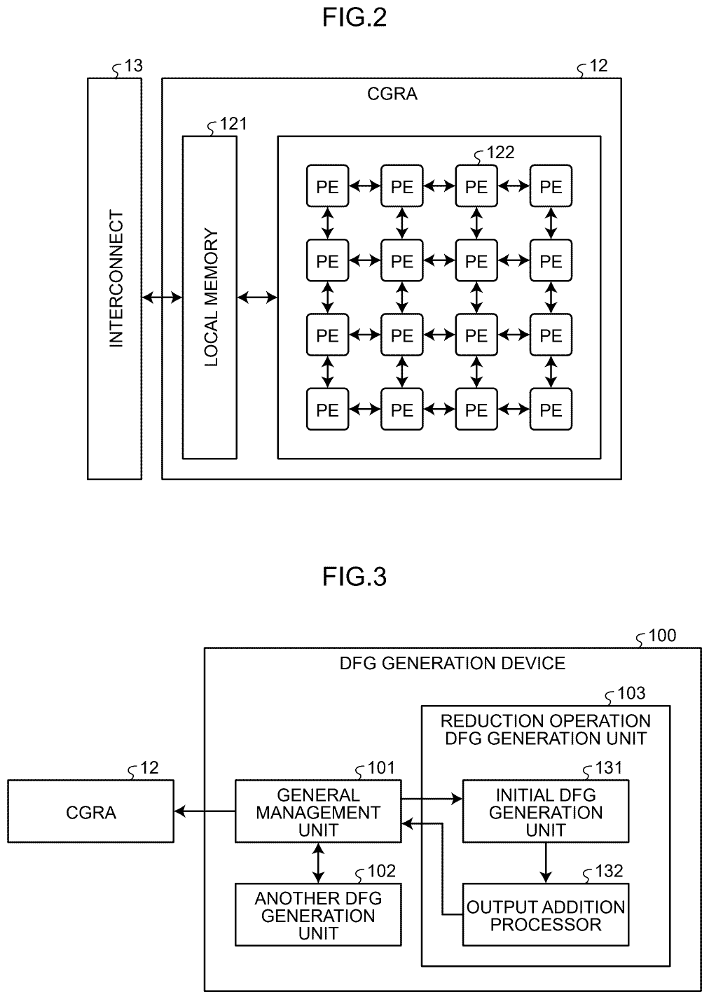

FIG. 1 is a hardware configuration diagram of an arithmetic device equipped with a CGRA. FIG. 2 is a hardware configuration diagram of the CGRA.

An arithmetic device 1 includes a central processing unit (CPU) 11, a CGRA 12, an interconnect 13, a memory controller 14, a memory 15, an input output (IO) controller 16, and an IO device 17. The arithmetic device 1 performs operation using the CGRA 12 and executes various data processing.

The CPU 11 includes a cache 111 such as a layer (L) 1 cache or an L2 cache. There may be a plurality of CPUs 11. The CPU 11 is connected to the interconnect 13. The CPU 11 transmits and receives data to and from the CGRA 12, the memory controller 14, and the IO controller 16 via the interconnect 13.

For example, the CPU 11 converts a given program into a DFG using a compiler. The DFG is information of an operation circuit configuration including functional units to be used, a connection path between the functional units, and an output path of the operation result regarding a predetermined operation.

Then, based on the generated DFG, the CPU 11 determines the PEs 122 to perform an operation in accordance with the CGRA 12, and determines the operation content to be executed by each PE 122 and the connection between the PEs 122. Thereafter, the CPU 11 performs mapping that causes the CGRA 12 to perform allocation to each PE 122 with the determined content.

The CGRA 12 includes a local memory 121. The CGRA 12 transmits and receives data to and from the CPU 11 via the memory 15.

More specifically, as illustrated in FIG. 2, the CGRA 12 includes the PEs 122 which are functional units arranged in a two-dimensional array, in addition to the local memory 121. The CGRA 12 determines the PEs 122 to be used according to the DFG designated by the CPU 11, connects the PEs 122 to each other, and determines the operation content to be executed by each PE 122. For example, in the case of the reduction operation, the CGRA 12 causes each PE 122 to execute a predetermined operation that is repeatedly executed as the reduction operation. Here, the reduction operation is an operation for obtaining an operation result by repeating a predetermined operation on two pieces of data from one set of input data or output data from another functional unit, based on one set of input data including two pieces of data.

Then, the CGRA 12 receives an input of data used for the operation and executes the calculation using the PEs 122. For example, the CGRA 12 causes the PEs 122 to execute a reduction operation based on the input data to obtain an operation result.

The interconnect 13 has a cache corresponding to a last level cache (LLC). The CPU 11, the CGRA 12, the memory controller 14, and the IO controller 16 are connected to the interconnect 13. The interconnect 13 mediates transmission and reception of data between the CPU 11, the CGRA 12, the memory controller 14, and the IO controller 16 using its own cache.

The memory controller 14 is connected to the interconnect 13. The memory controller 14 transmits and receives data to and from the CPU 11 and the CGRA 12 via the interconnect 13. In addition, the memory controller 14 executes writing and reading of data to and from the memory 15.

The memory 15 is a main storage memory. For example, as the memory 15, for example, a dynamic random access memory (DRAM) can be used.

The IO controller 16 is connected to the interconnect 13. The IO controller 16 transmits and receives data to and from the CPU 11 and the CGRA 12 via the interconnect 13. In addition, the IO controller 16 controls the IO device 17. The IO device 17 is, for example, a hard disk, a solid state drive (SSD), or the like.

FIG. 3 is a block diagram of a DFG generation device according to the first embodiment. A DFG generation device 100 corresponds to a DFG generation function of the arithmetic device 1. The DFG generation device 100 corresponds to an example of the “information processing apparatus”. For example, the DFG generation device 100 generates a DFG having an operation configuration including a functional units to be used, a connection path between the functional units, and an output path of an operation result for various operations including a reduction operation.

The DFG generation device 100 is realized by the CPU 11, the interconnect 13, the memory controller 14, and the memory 15 in FIG. 1. As illustrated in FIG. 3, the DFG generation device 100 includes a general management unit 101, another DFG generation unit 102, and a reduction operation DFG generation unit 103.

The general management unit 101 collectively manages the entire DFG generation processing. For example, the general management unit 101 acquires a program to be executed and determines whether or not the program includes an operation that is a reduction operation and for which the loop count is confirmed at the time of compilation. Here, the loop count is a degree of parallelism of a predetermined operation executed in one loop.

In a case where there is an operation that is a reduction operation and for which the loop count is confirmed at the time of compilation, the general management unit 101 outputs the operation to the reduction operation DFG generation unit 103 and causes the reduction operation DFG generation unit 103 to generate a DFG. At this time, the general management unit 101 notifies the reduction operation DFG generation unit 103 of the designated loop unrolling factor. Here, in the reduction operation, a plurality of sets of two elements is initially input, and the sets of two elements initially input is referred to as “operation input data”. The loop unrolling factor is the number of functional units that perform a predetermined operation using operation input data as a direct input.

The loop unrolling factor is designated by a user. In a case where the user designates a large loop unrolling factor, a larger number of operation resources are secured for one operation. The general management unit 101 may designate the loop unrolling factor in advance, or may receive an input from an input device (not illustrated) at the time of generating the DFG.

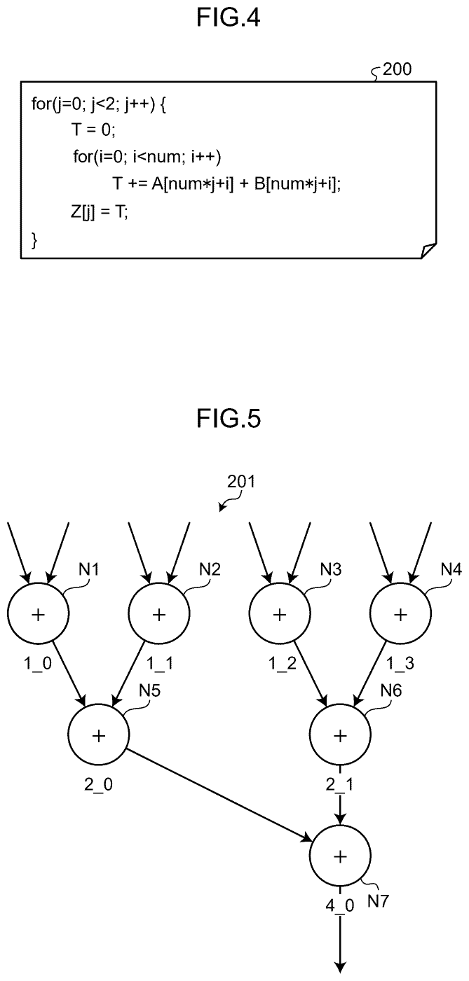

FIG. 4 is a diagram illustrating an example of a code having a reduction operation and a loop. For example, in a case where the code 200 illustrated in FIG. 4 is found in the program, the general management unit 101 confirms that the reduction operation is an addition reduction operation of T+=A(num*j+i)+B(num*j+i) (here, for convenience of explanation, the parentheses in the reduction operation are represented as “( )”). In this case, the predetermined operation is addition. Further, since “num” designating the loop count is determined at the time of compiling, the general management unit 101 determines that the operation is an operation for which the loop count is confirmed at the time of compiling. In this case, the general management unit 101 causes the reduction operation DFG generation unit 103 to create a DFG of an operation indicated by the code 200.

Here, i is the number of predetermined operations of the reduction operation executed in one loop for the loop of j, and is the degree of parallelism of the predetermined operation for the loop of j. In other words, as described above, the loop count can be referred to as a degree of parallelism of a predetermined operation executed in one loop.

On the other hand, the general management unit 101 outputs the operation to the another DFG generation unit 102 and causes the another DFG generation unit 102 to generate a DFG for operations other than the operation that is a reduction operation and for which the loop count is confirmed at the time of compilation.

Thereafter, the general management unit 101 acquires the DFG generated by the reduction operation DFG generation unit 103 or the another DFG generation unit 102. Then, the general management unit 101 performs mapping on the CGRA 12 according to the generated DFG.

The another DFG generation unit 102 receives, from the general management unit 101, an instruction to generate a DFG for an operation other than an operation that is a reduction operation and for which the loop count is confirmed at the time of compilation. Then, the other DFG generation unit 102 generates a DFG for the designated operation and outputs the generated DFG to the general management unit 101.

The reduction operation DFG generation unit 103 receives, from the general management unit 101, an instruction to generate a DFG for an operation that is a reduction operation and for which the loop count is confirmed at the time of compilation. Then, the reduction operation DFG generation unit 103 generates a DFG for an operation that is a reduction operation and for which the loop count is confirmed at the time of compilation, and outputs the generated DFG to the general management unit 101. Hereinafter, details of the operation of the reduction operation DFG generation unit 103 will be described. As illustrated in FIG. 3, the reduction operation DFG generation unit 103 includes an initial DFG generation unit 131 and an output addition processor 132.

The initial DFG generation unit 131 receives an input of the loop unrolling factor from the general management unit 101. Then, the initial DFG of a tree structure is generated with the designated loop unrolling factor for the designated operation.

The initial DFG generation unit 131 arranges nodes corresponding to the designated loop unrolling factor. A set of input data including two pieces of data is input to the node, and the node performs a predetermined operation using the set of input data.

Next, the initial DFG generation unit 131 generates an initial DFG by hierarchically arranging nodes that execute the predetermined operation using outputs from the arranged two nodes as inputs and repeating the hierarchization until the number of nodes becomes one. The nodes in the second and subsequent layers perform the predetermined operation with two pieces of output data from other nodes as inputs. Thereafter, the initial DFG generation unit 131 outputs the generated initial DFG to the output addition processor 132. Here, the initial operation DFG is a DFG in a case where the loop count is one, that is, in a case where one predetermined operation is executed in one loop.

This initial DFG corresponds to an example of an “initial operation configuration”. The initial DFG generation unit 131 corresponds to an example of an “initial operation configuration generation unit”. In other words, the initial DFG generation unit 131 generates an initial operation configuration based on the loop unrolling factor, which is the number of functional units that perform a predetermined operation using operation input data as a direct input. More specifically, the initial DFG generation unit 131 generates an initial configuration which is an operation configuration in which one set of input data is input to the number of functional units of the loop unrolling factor to execute the reduction operation, and in which a predetermined operation is repeated with a degree of parallelism of one.

For example, a case where the DFG is generated for the code 200 illustrated in FIG. 4 and four is designated as the loop unrolling factor will be described. FIG. 5 is a diagram illustrating an initial DFG in a case where the loop unrolling factor is four.

In this case, the initial DFG generation unit 131 sets the number of PEs 122 in the first layer to which data is input to four since the loop unrolling factor is four. Here, a target that is a functional unit in the DFG and to which the PE 122 is allocated is referred to as a “node”. In other words, the initial DFG generation unit 131 first arranges the nodes N1 to N4 as nodes as illustrated in an initial DFG 201 of FIG. 5. An element of A( ) and an element of B( ) corresponding thereto can be input to the nodes N1 to N4. Here, A( ) represents an arbitrary element of A(num*j+i), and B( ) represents an arbitrary element of B(num*j+i). A set of the elements A( ) and B( ) input to the nodes in the first hierarchy is operation input data.

Further, the initial DFG generation unit 131 extends the output from each of the nodes N1 to N4. In FIG. 5, the output of each node is represented by a set of the number of operation input data used to obtain the output and an iteration number after loop unrolling. Hereinafter, the number of operation input data used to obtain the output is simply referred to as “the number of operation input data”. The iteration number represents a number at a same hierarchy in a DFG represented by a tree structure. Here, the iteration numbers are assigned sequentially from zero from the left side in the drawing.

The nodes N1 to N4 each output, as output data, an operation result using a piece of different operation input data. For example, it is considered a case where A(0) and B(0) are input to the node N1, A(1) and B(1) are input to the node N2, A(2) and B(2) are input to the node N3, and A(3) and B(3) are input to the node N4. Hereinafter, the case of this input is referred to as “input example”. In the case of the input example, the node N1 outputs an addition result using A(0) and B(0) as output data. Therefore, the output of the node N1 is output data 1_0, the output of the node N2 is output data 1_1, the output of the node N3 is output data 1_2, and the output of the node N4 is output data 1_3.

Next, the initial DFG generation unit 131 arranges, as a second layer, nodes that each perform addition using output data from two of the nodes N1 to N4. Here, the initial DFG generation unit 131 arranges a node N5 that performs addition using the output data 1_0 from the node N1 and the output data 1_1 from the node N2 as inputs. In addition, the initial DFG generation unit 131 arranges a node N6 that performs addition using the output data 1_2 from the node N3 and the output data 1_3 from the node N4 as inputs. Here, the nodes N5 and N6 output, as output data, operation results using the two pieces of the operation input data. For example, in the case of the input example, the node N5 outputs, as output data, an operation result using A(0) and B(0) and A(1) and B(1). Therefore, the output of the node N5 is output data 2_0, and the output of the node N6 is output data 2_1.

Next, the initial DFG generation unit 131 arranges, as a third layer, a node N7 that performs addition using the output data 2_0 from the node N5 and the output data 2_1 from the node N6 as inputs. The node N7 outputs, as output data, an operation result using four pieces of operation input data. For example, in the case of the input example, the node N7 outputs, as output data, an operation result using A(0) and B(0), A(1) and B(1), A(2) and B(2), and A(3) and B(3). Therefore, the output of the node N7 is output data 4_0. As described above, the initial DFG generation unit 131 generates the initial DFG 201.

Returning to FIG. 3, the description will be continued. The output addition processor 132 receives an input of an initial DFG from the initial DFG generation unit 131. Next, the output addition processor 132 adds, to the initial DFG, an output of output data that is an operation result using two or more pieces of operation input data equal to or less than the number of operation input data used in the operation of the output data output by the initial DFG. For example, in a case where the loop unrolling factor is four, the output of the initial DFG is the operation result of the four pieces of operation input data. Therefore, the output addition processor 132 adds, to the initial DFG, an output having an operation result using two pieces of operation input data as output data and an output having an operation result using three pieces of operation input data as output data to complete the DFG. The output addition processor 132 outputs the completed DFG to the general management unit 101.

A procedure of adding the output to the initial DFG by the output addition processor 132 will be described in detail. The output addition processor 132 determines an output candidate to be added. Here, similarly to the output data of the initial DFG, the output data of the output to be added is represented by the number of pieces of operation input data and the iteration number used to obtain the output to be added. For example, the output addition processor 132 sets the outputs of the output data 2_0, 2_1, . . . and the output data 3_0, 3_1, . . . as output candidates to be added. Hereinafter, the output data output from the output that is a candidate designated by the output addition processor 132 is generalized and represented as “output data a_b”.

Next, the output addition processor 132 determines whether the output data a_b of the output as a candidate is an output of the initial DFG. In a case where the output data a_b is the output of the initial DFG, since there is already an output, the output addition processor 132 does not add the output of the candidate. On the other hand, in a case where the output data a_b is not the output of the initial DFG, the output addition processor 132 performs the following processing.

The output addition processor 132 decomposes a corresponding to the number of pieces of operation input data into x+y. Here, x is the largest number in the power of two. Further, y is a number of zero or more. Furthermore, a is the loop count in a case where the output data a_b is the final operation result. In other words, for example, in a case where the loop count until the output data is obtained is expressed in binary numbers, the most significant bit corresponds to x, and the other bits correspond to y.

Next, the output addition processor 132 calculates the logarithm of x with base two, adds one, and multiplies the addition result by b to calculate α, which is a first parameter. In other words, the output addition processor 132 calculates α by an expression of α=b*(log₂(x)+1). Here, “*” represents multiplication.

Next, in a case where y is larger than zero, that is, other than zero, the output addition processor 132 multiplies the value obtained by adding one to a by x and divides the multiplication result by the power of (y−1) of two to calculate β, which is a second parameter. In other words, the output addition processor 132 calculates B by an expression of β=(α+1)*x/2^{y-1}.

Then, the output addition processor 132 specifies input data used for operation for the output data in the output to be added as follows. In a case where y is larger than zero, that is, other than zero, the output addition processor 132 specifies the output data x_α and the output data y_β as input data used for calculation. In this case, the output addition processor 132 performs calculation using the output data x_α and the output data y_β, newly adds a node that outputs the output data to the initial DFG, and adds an output from the added node as an output of the DFG.

Furthermore, in a case where y is zero, the output addition processor 132 determines that the output data in the output to be added can be calculated if there is the output data x_α. In other words, the output addition processor 132 determines that the output data x_α can be output data in the output to be added. Here, it can be said that y=0 and x is equal to a. Then, a is a power of two, and a_b exists in the initial DFG regardless of the value of b. Therefore, the output addition processor 132 adds the output from the node that outputs the output data a_b as the output of the DFG.

However, the upper limit of the iteration number is the number that is zero or more and that does not exceed the loop unrolling factor as a result of multiplying the value obtained by adding one to the iteration number by the number of pieces of operation input data. In a case where the iteration number of the output data of the candidate output exceeds the upper limit, the output addition processor 132 does not add the candidate output, increases the number of pieces of operation input data by one, and repeats the processing. Furthermore, in a case where the number of operation input data exceeds the loop unrolling factor, the output addition processor 132 ends the output addition process. As described above, the output addition processor 132 completes the DFG.

Here, the DFG of which the output is added to the initial DFG by the output addition processor 132 corresponds to an example of a “first operation configuration”. As described above, the output addition processor 132 generates the first operation configuration by adding the output path of the operation result for the different degree of parallelism in a case where the predetermined operation is repeated with the predetermined degree of parallelism to the initial DFG which is the initial operation configuration. More specifically, the output addition processor 132 adds the output path of the operation result for each case where the degree of parallelism of the predetermined operation is two or more and equal to or less than the loop unrolling factor.

In addition, the output data x_α and y_β in a case where the operation result obtained by repeating the predetermined operation with a predetermined degree of parallelism is set as the output data a_b corresponds to an example of “two pieces of data used for the predetermined operation for calculating the operation result for different degree of parallelism”. In other words, the output addition processor 132 specifies two pieces of data used for the predetermined operation for calculating the operation result for different degree of parallelism based on the number of operation input data used for obtaining the operation result by repeating the predetermined operation with a predetermined degree of parallelism, and adds an output path based on the specified two pieces of data.

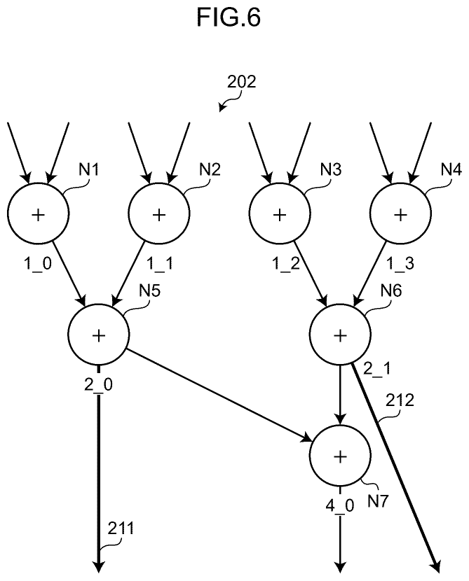

Here, a case where four is designated as the loop unrolling factor when creating the DFG of the code 200 illustrated in FIG. 4 will be described. FIG. 6 is a diagram illustrating addition of an output in a case where the loop unrolling factor is four and the loop count is two.

The output addition processor 132 acquires the initial DFG 201 illustrated in FIG. 5 for the code 200. Then, the output addition processor 132 sets the outputs of the output data 2_0, 2_1, . . . and the output data 3_0, 3_1, . . . as output candidates to be added in a case where the number of pieces of operation input data is two or three, that is, a case where the loop count is two or three.

The output addition processor 132 considers output candidates in a case where the number of pieces of operation input data is two, that is, the loop count is two. In this case, the output addition processor 132 determines the addition of the output by setting a=2 in the output data a_b to be output and changing the value of b as follows.

In a case where b=0, the output addition processor 132 determines that the output data 2_0 is not the output of the initial DFG 201. Next, the output addition processor 132 decomposes a=2+0 to x=2 and y=0. Then, since y=0, the output addition processor 132 determines that a node that outputs the output data 2_0 exists in the initial DFG 201, and specifies a node N5 that outputs the output data 2_0 from the initial DFG 201. Thereafter, the output addition processor 132 adds an output 211 of the output data 2_0 from the node N5 to the initial DFG 201.

In a case where b=1, the output addition processor 132 determines that the output data 2_1 is not the output of the initial DFG 201. Next, the output addition processor 132 decomposes a=2+0 to x=2 and y=0. Then, since y=0, the output addition processor 132 determines that a node that outputs the output data 2_1 exists in the initial DFG 201, and specifies the node N6 that outputs the output data 2_1 from the initial DFG 201. Thereafter, the output addition processor 132 adds an output 212 of the output data 2_1 from the node N6 to the initial DFG 201.

In addition, in a case where b=2, since 2*(2+1)=5 exceeds the loop unrolling factor of four, the output addition processor 132 ends the addition of the output in a case where the loop count is two. As described above, the output addition processor 132 generates a DFG 202 to which the output in the case where the loop counts is two is added.

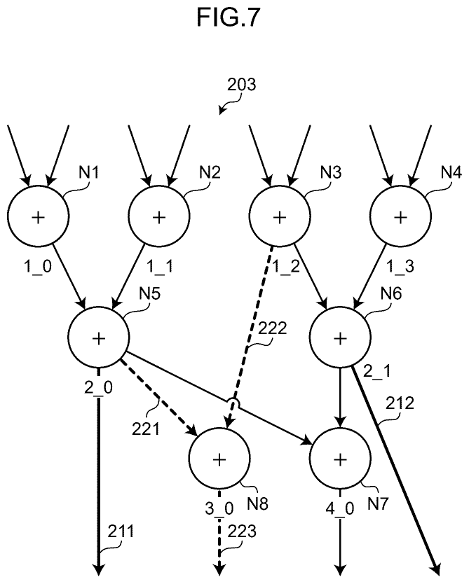

Next, the output addition processor 132 considers output candidates in a case where the number of operation input data is three, that is, the loop counts is three. In this case, the output addition processor 132 determines the addition of the output by setting a=3 in the output data a_b to be output and changing the value of b as follows. FIG. 7 is a diagram illustrating addition of an output in a case where the loop unrolling factor is four and the loop count is three.

In a case where b=0, the output addition processor 132 determines that the output data 3_0 is not the output of the initial DFG 201. Next, the output addition processor 132 decomposes a=2+1 to x=2 and y=1. Then, the output addition processor 132 calculates α as α=0*(log₂(2)+1)=0. Further, the output addition processor 132 calculates β as β=((0+1)*2)/2⁰=2. Then, as illustrated in FIG. 6, the output addition processor 132 adds a node N8 that performs calculation using the output data 2_0 (output data x_α) and the output data 1_2 (output data y_β) as inputs. The output addition processor 132 adds an output 221 from the node N5 and an output 222 from the node N3 to the DFG 202 and connects them to the node N8. Further, the output addition processor 132 adds, to the DFG 202, the output 223 output from the node N8 to the output data 3_0.

Furthermore, in a case where b=1, since 3*(1+1)=6, which exceeds the loop unrolling factor of four, the output addition processor 132 ends the addition of the output in a case where the loop count is three. As described above, the output addition processor 132 generates a DFG 203 to which the output in the case where the loop count is three is added.

Next, the output addition processor 132 considers output candidates in a case where the number of operation input data is four, that is, the loop count is four. In this case, the output addition processor 132 determines the addition of the output by setting a=4 in the output data a_b to be output and changing the value of b as follows.

In a case where b=0, the output addition processor 132 determines that the output data 4_0 is the output of the initial DFG 201. In this case, since the output already exists in the initial DFG 201, the output addition processor 132 ends the addition of the output candidate.

Next, in a case where b=1, since 4*(1+1)=8 exceeds the loop unrolling factor of four, the output addition processor 132 ends the addition of the output in a case where the loop count is four.

Next, the output addition processor 132 considers output candidates in a case where the number of operation input data is five, that is, the loop count is five. Since the number of operation input data exceeds the loop unrolling factor of four, the output addition processor 132 ends the output addition process.

By adding the output in this manner, for example, in a case where the loop count is two and the initial DFG 201 of FIG. 5 is used, the nodes N3, N4, and N6 are wasted. On the other hand, by using the DFG generation device 100 according to the first embodiment, in the DFG 203, one operation in a case where the loop count is two can be performed at the nodes N1, N2, and N5, and at the same time, one operation in a case where the loop count is two can be performed at the nodes N3, N4, and N6. Therefore, by mapping the DFG 203 to the CGRA 12, it is possible to reduce the occurrence of the PEs 122 that are not needed in the operation.

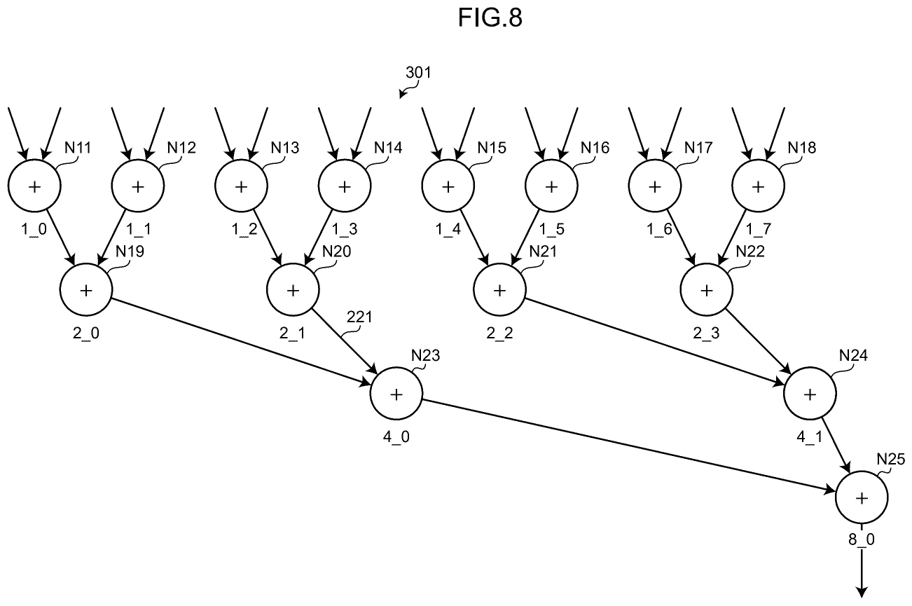

Here, as another example, a case where the loop unrolling factor is eight will be described. FIG. 8 is a diagram illustrating an initial DFG in a case where the loop unrolling factor is eight. In a case where the DFG of the code 200 illustrated in FIG. 4 is generated and eight is designated as the loop unrolling factor, the initial DFG generation unit 131 generates an initial DFG 301 having nodes N11 to N25 illustrated in FIG. 8 according to the loop unrolling factor of eight. Also in FIG. 8, the output data of each of the nodes N11 to N25 is represented by a set of the number of pieced of operation input data and an iteration number after loop unrolling.

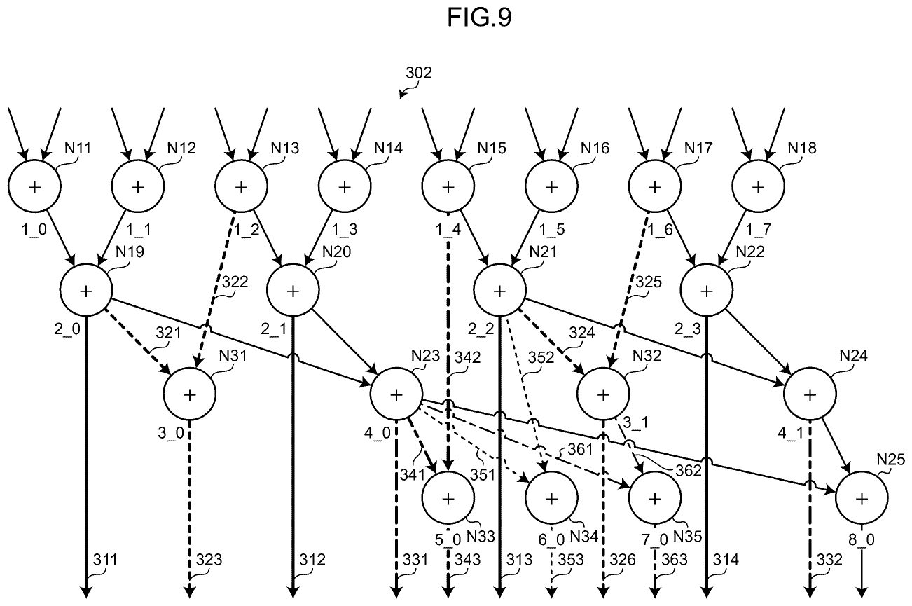

Then, the output addition processor 132 executes the following output addition processing on the initial DFG 301. FIG. 9 is a diagram illustrating a completed DFG in a case where the loop unrolling factor is eight.

The output addition processor 132 considers output candidates in a case where the number of pieces of operation input data is two, that is, the loop count is two. In this case, the output addition processor 132 determines the addition of the output by setting a=2 in the output data a_b to be output and changing the value of b as follows.

In a case where b=0, the output addition processor 132 determines that the output data 2_0 is not the output of the initial DFG 301. Next, the output addition processor 132 decomposes a=2+0 to x=2 and y=0. Then, since y=0, the output addition processor 132 determines that a node that outputs the output data 2_0 exists in the initial DFG 201, and specifies the node N19 that outputs the output data 2_0 from the initial DFG 201. Thereafter, the output addition processor 132 adds an output 311 of the output data 2_0 from a node N19 to the initial DFG 301.

In a case where b=1, the output addition processor 132 determines that the output data 2_1 is not the output of the initial DFG 301. Next, the output addition processor 132 decomposes a=2+0 to x=2 and y=0. Then, since y=0, the output addition processor 132 determines that a node that outputs the output data 2_0 exists in the initial DFG 201, and specifies the node N20 that outputs the output data 2_1 from the initial DFG 301. Thereafter, the output addition processor 132 adds the output 312 of the output data 2_1 from the node N20 to the initial DFG 301.

In a case where b=2, the output addition processor 132 determines that the output data 2_2 is not the output of the initial DFG 301. Next, the output addition processor 132 decomposes a=2+0 to x=2 and y=0. Then, since y=0, the output addition processor 132 determines that a node that outputs the output data 2_2 exists in the initial DFG 201, and specifies the node N21 that outputs the output data 2_2 from the initial DFG 201. Thereafter, the output addition processor 132 adds an output 313 of the output data 2_0 from the node N21 to the initial DFG 301.

In a case where b=3, the output addition processor 132 determines that the output data 2_3 is not the output of the initial DFG 301. Next, the output addition processor 132 decomposes a=2+0 to x=2 and y=0. Then, since y=0, the output addition processor 132 determines that a node that outputs the output data 2_3 exists in the initial DFG 201, and specifies the node N22 that outputs the output data 2_3 from the initial DFG 201. Thereafter, the output addition processor 132 adds an output 314 of the output data 2_3 from the node N22 to the initial DFG 301.

Furthermore, in a case where b=4, since 2*(4+1)=10 exceeds the loop unrolling factor of eight, the output addition processor 132 ends the addition of the output in a case where the loop count is two.

Next, the output addition processor 132 considers output candidates in a case where the number of operation input data is three, that is, the loop counts is three. In this case, the output addition processor 132 determines the addition of the output by setting a=3 in the output data a_b to be output and changing the value of b as follows.

In a case where b=0, the output addition processor 132 determines that the output data 3_0 is not the output of the initial DFG 201. Next, the output addition processor 132 decomposes a=2+1 to x=2 and y=1. Then, the output addition processor 132 calculates α as α=0*(log₂(2)+1)=0. Further, the output addition processor 132 calculates β as β=((0+1)*2)/2⁰=2. Then, the output addition processor 132 adds a node N31 that performs calculation using the output data 2_0 (output data x_α) and the output data 1_2 (output data y_β) as inputs. The output addition processor 132 adds an output 321 from the node N19 and an output 322 from the node N13 to the initial DFG 301 and connects them to the node N31. Further, the output addition processor 132 adds, to the initial DFG 301, an output 323 that outputs the output data 3_0 from the node N31.

In a case where b=1, the output addition processor 132 determines that the output data 3_1 is not the output of the initial DFG 201. Next, the output addition processor 132 decomposes a=2+1 to x=2 and y=1. Then, the output addition processor 132 calculates α as α=1*(log₂(2)+1)=2. Further, the output addition processor 132 calculates β as β=((6+1)*2)/2⁰=6. Then, the output addition processor 132 adds a node N32 that performs calculation using the output data 2_2 (output data x_α) and the output data 1_6 (output data y_β) as inputs. The output addition processor 132 adds an output 324 from the node N21 and an output 325 from the node N17 to the initial DFG 301 and connects them to the node N32. Further, the output addition processor 132 adds an output 326 that outputs the output data 3_1 from the node N32 to the initial DFG 301.

In addition, in a case of b=2, since 3*(2+1)=9 exceeds the loop unrolling factor of eight, the output addition processor 132 ends the addition of the output in a case where the loop count is three.

Next, the output addition processor 132 considers output candidates in a case where the number of operation input data is four, that is, the loop count is four. In this case, the output addition processor 132 determines the addition of the output by setting a=4 in the output data a_b to be output and changing the value of b as follows.

In a case where b=0, the output addition processor 132 determines that the output data 4_0 is not the output of the initial DFG 201. Next, the output addition processor 132 decomposes a=4+0 to x=4 and y=0. Then, since y=0, the output addition processor 132 determines that a node that outputs the output data 4_0 exists in the initial DFG 201, and specifies the node N23 that outputs the output data 4_0 from the initial DFG 201. Thereafter, the output addition processor 132 adds an output 331 of the output data 4_0 from the node N23 to the initial DFG 301.

In a case where b=1, the output addition processor 132 determines that the output data 4_1 is not the output of the initial DFG 201. Next, the output addition processor 132 decomposes a=4+0 to x=4 and y=0. Then, since y=0, the output addition processor 132 determines that a node that outputs the output data 4_1 exists in the initial DFG 201, and specifies the node N24 that outputs the output data 4_1 from the initial DFG 201. Thereafter, the output addition processor 132 adds an output 332 of the output data 4_1 from the node N24 to the initial DFG 201.

Furthermore, in a case of b=2, since 4*(2+1)=12 exceeds the loop unrolling factor of eight, the output addition processor 132 ends the addition of the output in a case where the loop count is four.

Next, the output addition processor 132 considers output candidates in a case where the number of operation input data is five, that is, the loop count is five. In this case, the output addition processor 132 determines the addition of the output by setting a=5 in the output data a_b to be output and changing the value of b as follows.

In a case where b=0, the output addition processor 132 determines that the output data 5_0 is not the output of the initial DFG 201. Next, the output addition processor 132 decomposes a=4+1 to x=4 and y=1. Then, the output addition processor 132 calculates α as α=0*(log₂(4)+1)=0. Further, the output addition processor 132 calculates β as β=((0+1)*4)/2⁰=4. Then, the output addition processor 132 adds a node N33 that performs calculation using the output data 4_0 (output data x_α) and the output data 1_4 (output data y_β) as inputs. The output addition processor 132 adds an output 341 from the node N12 and an output 342 from the node N15 to the initial DFG 301 and connects them to the node N33. Further, the output addition processor 132 adds, to the initial DFG 301, an output 343 that outputs the output data 5_0 from the node N33.

In addition, in a case of b=1, since 5*(1+1)=10 exceeds the loop unrolling factor of eight, the output addition processor 132 ends the addition of the output in a case where the loop count is five.

Next, the output addition processor 132 considers output candidates in a case where the number of operation input data is six, that is, the loop count is six. In this case, the output addition processor 132 determines the addition of the output by setting a=6 in the output data a_b to be output and changing the value of b as follows.

In a case where b=0, the output addition processor 132 determines that the output data 6_0 is not the output of the initial DFG 201. Next, the output addition processor 132 decomposes a=4+2 to x=4 and y=2. Then, the output addition processor 132 calculates α as α=0*(log₂(4)+1)=0. Further, the output addition processor 132 calculates β as β=((0+1)*4)/2=2. Then, the output addition processor 132 adds a node N34 that performs calculation using the output data 4_0 (output data x_α) and the output data 2_2 (output data y_β) as inputs. The output addition processor 132 adds an output 351 from the node N23 and an output 352 from the node N21 to the initial DFG 301 and connects the nodes to the node N34. Further, the output addition processor 132 adds an output 353 that outputs the output data 6_0 from the node N34 to the initial DFG 301.

Furthermore, in a case where b=1, since 6*(1+1)=12 exceeds the loop unrolling factor of eight, the output addition processor 132 ends the addition of the output in a case where the loop count is six.

Next, the output addition processor 132 considers output candidates in a case where the number of operation input data is seven, that is, the loop count is seven. In this case, the output addition processor 132 determines the addition of the output by setting a=7 in the output data a_b to be output and changing the value of b as follows.

In a case where b=0, the output addition processor 132 determines that the output data 7_0 is not the output of the initial DFG 201. Next, the output addition processor 132 decomposes a=4+3 to x=4 and y=3. Then, the output addition processor 132 calculates α as α=0*(log₂(4)+1)=0. Further, the output addition processor 132 calculates β as β=((0+1)*4)/4=1. Then, the output addition processor 132 adds a node N35 that performs calculation using the output data 4_0 (output data x_α) and the output data 3_1 (output data y_β) as inputs. The output addition processor 132 adds an output 361 from the node N23 and an output 362 from the node N32 to the initial DFG 301 and connects the nodes to the node N35. Further, the output addition processor 132 adds, to the initial DFG 301, an output 363 that outputs the output data 7_0 from the node N35.

Furthermore, in a case of b=1, since 7*(1+1)=14 exceeds the loop unrolling factor of eight, the output addition processor 132 ends the addition of the output in a case where the loop count is six.

Next, the output addition processor 132 considers output candidates in a case where the number of operation input data is eight, that is, the loop count is eight. In this case, the output addition processor 132 determines the addition of the output by setting a=8 in the output data a_b to be output and changing the value of b as follows.

In a case of b=0, the output addition processor 132 determines that the output data 8_0 is the output of the initial DFG 201. In this case, since the output already exists in the initial DFG 201, the output addition processor 132 ends the addition of the output candidate.

Next, in a case of b=1, since 8*(1+1)=16 exceeds the loop unrolling factor of eight, the output addition processor 132 ends the addition of the output in a case where the loop count is four.

Next, the output addition processor 132 considers output candidates in a case where the number of operation input data is nine, that is, the loop count is nine. Since the number of operation input data exceeds the loop unrolling factor of eight, the output addition processor 132 ends the output addition process. As described above, the output addition processor 132 completes a DFG 302 illustrated in FIG. 9.

The CGRA 12 receives mapping of the generated DFG from the general management unit 101 of the DFG generation device 100. In the case of a reduction operation and an operation for which the loop count is confirmed at the time of compilation, in the CGRA 12, mapping is performed on a DFG that outputs each output data in the case of a different loop counts. Therefore, for this calculation, the CGRA 12 writes all the output data in the case of different loop count to the local memory 121, and changes the data to be read according to the loop count.

For example, in a case where the DFG 203 illustrated in FIG. 7 is mapped, the CGRA 12 writes the output data 2_0, 2_1, 3_0, and 4_0 to the local memory 121. Then, in a case where the loop count is two, the CGRA 12 selects the output data 2_0 and 2_1. In a case where the loop count is three, CGRA 12 selects output data 3_0. In a case where the loop count is four, CGRA 12 selects output data 4_0.

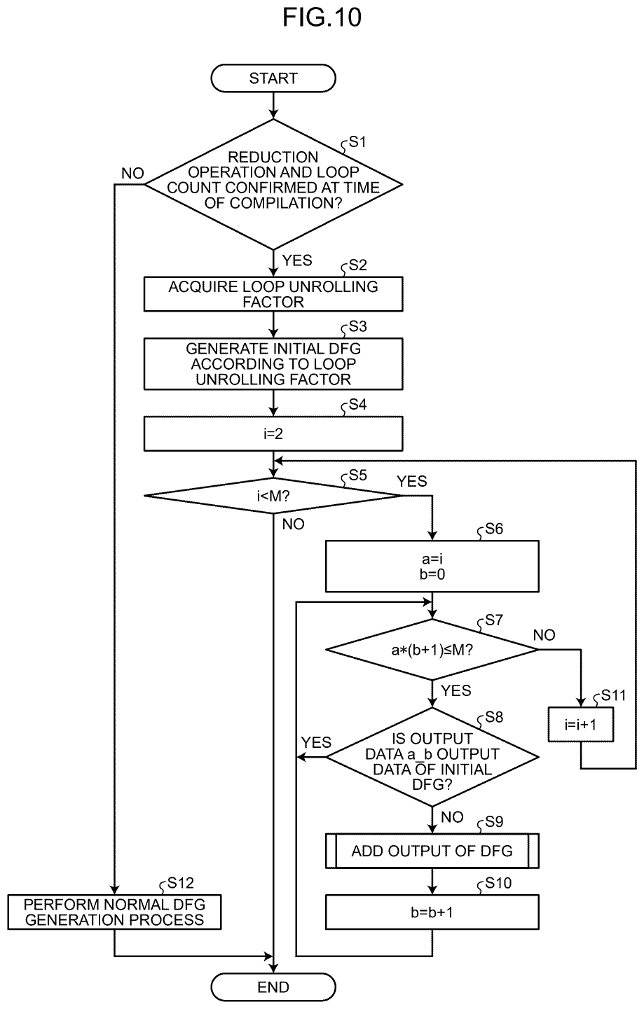

FIG. 10 is a flowchart of a DFG generation process according to the first embodiment. Next, a flow of the DFG generation process by the DFG generation device 100 according to the first embodiment will be described with reference to FIG. 10.

The general management unit 101 determines whether the calculation for generating the DFG is a reduction operation and an operation for which the loop count is confirmed at the time of compilation (Step S1). In a case of an operation other than the reduction operation or the operation for which the loop count is confirmed at the time of compilation (Step S1: No), the other DFG generation unit 102 executes a normal DFG generation process for the calculation acquired from the general management unit 101 (Step S12).

On the other hand, in the case of an operation that is the reduction operation and for which the loop count is confirmed at the time of compilation (Step S1: Yes), the initial DFG generation unit 131 acquires the loop unrolling factor together with an operation for stopping the DFG from the general management unit 101 (Step S2).

Next, the initial DFG generation unit 131 generates an initial DFG according to the designated loop unrolling factor (Step S3). The initial DFG generation unit 131 generates and outputs the initial DFG to the output addition processor 132.

The output addition processor 132 sets i representing the loop count as i=2 (Step S4).

Next, the output addition processor 132 determines whether i is less than M which is the loop unrolling factor (Step S5).

In a case where i is less than M (Step S5: Yes), the output addition processor 132 sets a, which is the number of pieces of operation input data in a case where the output data is represented by the number of pieces of operation input data and the iteration number, as a=i and b, which is the iteration number, as b=0 (Step S6).

Next, the output addition processor 132 determines whether a*(b+1) is M or less which is the loop unrolling factor (Step S7).

In a case where a*(b+1) is equal to or less than M (Step S7: Yes), the output addition processor 132 determines whether the output data a_b is the output data of the initial DFG (Step S8). In a case where the output data a_b is output data output from the initial DFG (Step S8: Yes), the output addition processor 132 returns to Step S7.

On the other hand, in a case where the output data a_b is not output data output from the initial DFG (Step S8: No), the output addition processor 132 executes processing of adding an output of the DFG (Step S9).

Next, the output addition processor 132 increments b by one (Step S10). Thereafter, the output addition processor 132 returns to Step S7.

On the other hand, in a case where a*(b+1) is greater than M (Step S7: No), the output addition processor 132 increments i by one (Step S11). Thereafter, the output addition processor 132 returns to Step S5.

In a case where i is equal to or larger than M (Step S5: No), the output addition processor 132 ends the DFG generation process.

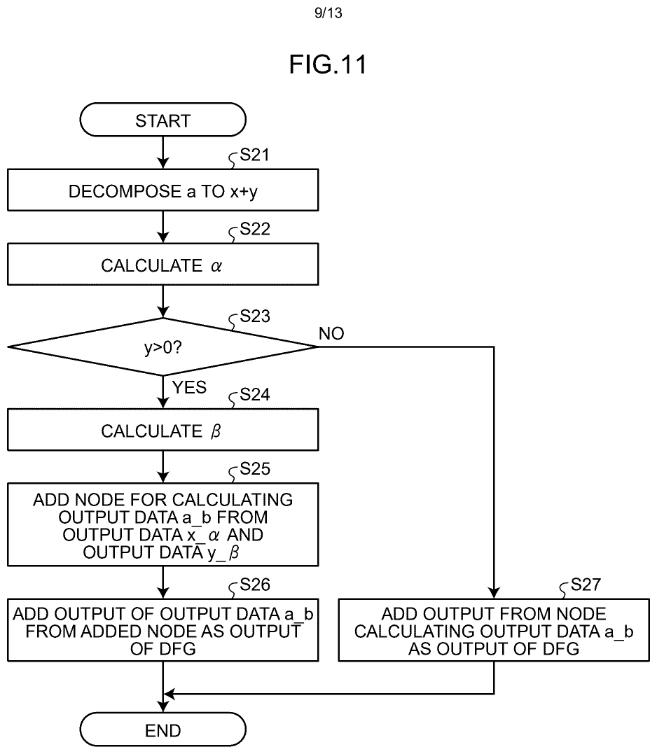

FIG. 11 is a flowchart of an output addition process of the DFG. The processing illustrated in the flow of FIG. 11 corresponds to an example of the processing executed in Step S9 of FIG. 10.

The output addition processor 132 decomposes a into x+y (Step S21). x that is equal to or less than a is the largest number in the power of two, and y is the remaining number.

Next, the output addition processor 132 calculates α=b*(log₂(x)+1) (Step S22).

Next, the output addition processor 132 determines whether or not y is greater than zero (Step S23).

In a case where y is greater than zero (Step S23: Yes), the output addition processor 132 calculates β=((α+1)*x)/2^{y-1} (Step S24).

Then, the output addition processor 132 adds a node that calculates the output data a_b from the output data x_α and the output data y_β to the initial DFG (Step S25).

Next, the output addition processor 132 adds the output of the output data a_b from the added node as an output of the DFG (Step S26).

On the other hand, in a case where y is zero or less (Step S23: No), the output addition processor 132 adds the output from the node calculating the output data a_b as the output of the DFG (Step S27).

As described above, the DFG generation device, which is the information processing apparatus according to the present embodiment, generates the initial DFG according to the loop unrolling factor in a case of generating the DFG of the reduction operation for which the loop count is confirmed at the time of compilation. Next, the DFG generation device adds an output of an operation result in each case to the initial DFG for each of different loop counts smaller than the loop count in the operation for calculating the output of the initial DFG.

As a result, the CGRA to which the DFG generated by the DFG generation device according to the present embodiment is mapped can obtain an operation result regardless of the loop count as long as the loop count is equal to or less than the designated loop unrolling factor. In addition, depending on the loop count, an operation result can be obtained in the middle of the tree of the mapped DFG, and another operation result can be obtained in parallel by the remaining operation resources, so that the operation resources can be efficiently used. Therefore, the utilization efficiency of the calculation resource can be improved.

### (b) Second Embodiment

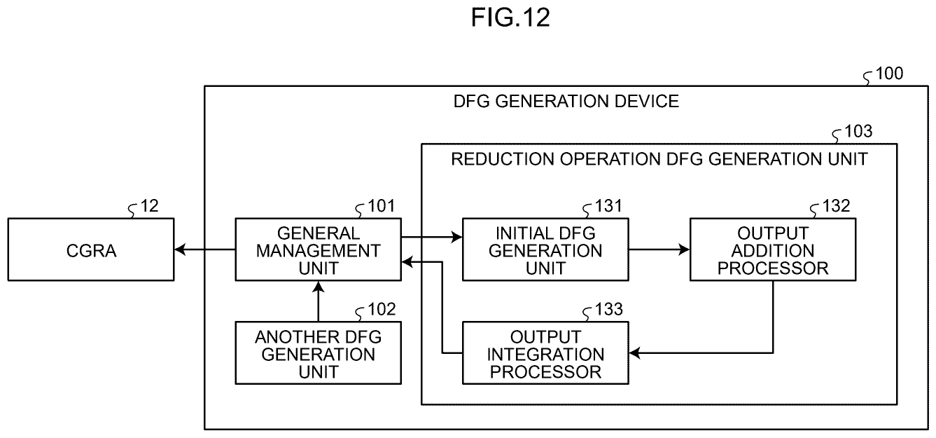

FIG. 12 is a block diagram of a DFG generation device according to a second embodiment. In the DFG generation method described in the first embodiment, the number of output data increases as the loop unrolling factor increases. Therefore, in a case where the loop unrolling factor increases, it is difficult to prepare all the outputs for different loop counts. In addition, in a case where all the outputs for different loop count are prepared, the number of allocated PEs 122 increases and it is difficult to be used Pes 122 for other calculations, and there is a possibility that the processing performance of the arithmetic device 1 as a whole deteriorates. In addition, in a case where all the outputs for different loop count are stored in the local memory 121, the memory size or the memory bandwidth may be insufficient.

Therefore, a DFG generation device 100 according to the present embodiment generates a DFG so as to combine operations which are operations in a case where the loop count is different and are not used at the same time into one operation and select data to be used for the operation by a multiplexer (MUX). In the DFG generation device 100 according to the present embodiment, as illustrated in FIG. 12, a reduction operation DFG generation unit 103 includes an output integration processor 133 in addition to an initial DFG generation unit 131 and an output addition processor 132. In the following description, description of operation of each unit similar to that of the first embodiment may be omitted. Hereinafter, the output integration processing will be mainly described.

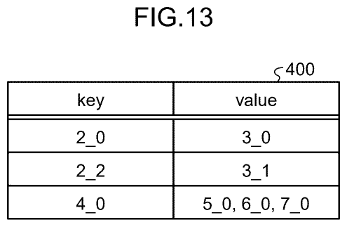

The output addition processor 132 includes a hash table 400 as illustrated in FIG. 13 in which a value indicating output data obtained by an operation using the output data is stored in association with a key indicating specific output data. FIG. 13 is a diagram illustrating an example of a hash table. In the hash table 400 of FIG. 13, a set of the number of pieces of operation input data indicating the output data and the iteration number is used as the values of the key and the value. The hash table 400 is used to determine an output to be integrated.

The output addition processor 132 adds an output for each different loop count to the initial DFG similarly to the first embodiment. Further, the output addition processor 132 determines whether the loop count of the added output is a power of two, that is, whether a, which is the number of pieces of operation input data, is a power of two. The output addition processor 132 can determine whether or not a is a power of two depending on whether or not y is zero in a case where a is decomposed into x and y, for example.

In a case where the loop count of the added output is the power of two, the output addition processor 132 does not register the output data of the added output and the output data used for the calculation of the output data in the hash table 400. In other words, the output addition processor 132 excludes the output in a case where the number of pieces of operation input data is the power of two from the integration target. This is because, in a case where the outputs in a case where the number of pieces of operation input data is the power of two are integrated, since a portion where the outputs are integrated is included in the middle of a series of operations in another loop count, the integrated portion of the outputs becomes multistage, and there is a concern about an increase in the number of cycles.

In a case where the loop count of the added output is not a power of two, the output addition processor 132 registers a key indicating the output data x_α among the output data used for the operation of the output data of the added output and a value indicating the output data of the added output in the hash table 400. Here, in a case where the same key has already been registered, the output addition processor 132 adds a value to value corresponding to the key.

The output addition processor 132 executes all the outputs to which the above determination is added to generate the hash table 400. Thereafter, the output addition processor 132 outputs the generated DFG and hash table 400 to the output integration processor 133.

The output integration processor 133 receives inputs of the generated DFG and the hash table 400 from the output addition processor 132. Next, the output integration processor 133 specifies a key in which a plurality of values is registered in the hash table 400. Next, the output integration processor 133 generates one multiplexer that collectively inputs the output data y_β used for calculating the output data indicated by each value corresponding to the specified key. Further, the output integration processor 133 adds a node that performs an operation in response to an input of the output data x_α used for an operation of the output data indicated by each value and the output data from the multiplexer, and sets an output from the node as an output of the DFG. In this case, the output integration processor 133 deletes the original input destination node of the collected output data y_β.

Here, the DFG in which the outputs from the plurality of nodes are collected by the multiplexer by the output integration processor 133 corresponds to an example of a “second operation configuration”. As described above, in the first operation configuration generated by the output addition processor 132, the output integration processor 133 combines some of the output paths added by the output addition processor 132 into one to generate the second operation configuration.

The output integration processor 133 generates a DFG in which outputs are integrated by the above output integration processing. By integrating in this manner, in a case where the output passes through the integrated portion, it takes an extra cycle to the final output, but the number of allocated PEs 122 can be reduced. Then, the output integration processor 133 outputs the generated DFG to a general management unit 101.

Here, for example, a case of integrating the outputs of the DFG 302 illustrated in FIG. 9 will be described. In this case, the DFG 302 corresponds to an intermediate state of the DFG generated by the DFG generation device 100 according to the present embodiment. The output addition processor 132 generates the hash table 400 as follows.

The output addition processor 132 considers the output data in a case where the number of pieces of operation input data is two, that is, the loop count is two. In this case, since y=0, the output addition processor 132 does not add information to the hash table 400.

Next, the output addition processor 132 considers the output data in a case where the number of pieces of operation input data is three, that is, the loop count is three. The output addition processor 132 sets a=3 in the output data a_b to be output, changes the value of b as follows, and determines addition of an output.

In a case where b=0, since the output data x_α used for the operation of the output data 3_0 is the output data 2_0, the output addition processor 132 adds information in which the key is 2_0 and the value is 3_0 to the hash table 400 as illustrated in FIG. 13.

In addition, in a case where b=1, since the output data x_α used for the operation of the output data 3_1 is the output data 2_2, the output addition processor 132 adds information in which the key is 2_2 and the value is 3_1 to the hash table 400 as illustrated in FIG. 13.

Next, the output addition processor 132 considers the output data in a case where the number of operation input data is four, that is, the loop count is four. In this case, since y=0, the output addition processor 132 does not add information to the hash table 400.

Next, the output addition processor 132 considers the output data in a case where the number of operation input data is five, that is, the loop count is five. The output addition processor 132 sets a=5 in the output data a_b to be output. Then, since b=0, the output addition processor 132 adds information in which the key is 4_0 and the value is 5_0 to the hash table 400 as illustrated in FIG. 13 since the output data x_α used for the operation of the output data 5_0 is the output data 4_0.

Next, the output addition processor 132 considers the output data in a case where the number of operation input data is six, that is, the loop count is six. The output addition processor 132 sets a=6 in the output data a_b to be output. Then, since b=0, the output addition processor 132 determines that the output data x_α used for the calculation of the output data 6_0 is the output data 4_0. In this case, since 4_0 has already been registered as a key as illustrated in FIG. 13, the output addition processor 132 adds the value to the hash table 400 of 6_0 in association with the key of 4_0.

Next, the output addition processor 132 considers the output data in a case where the number of operation input data is seven, that is, the loop count is seven. The output addition processor 132 sets a=7 in the output data a_b to be output. Then, since b=0, the output addition processor 132 determines that the output data x_α used for the calculation of the output data 7_0 is the output data 4_0. In this case, since 4_0 has already been registered as a key as illustrated in FIG. 13, the output addition processor 132 adds the value to the hash table 400 of 7_0 in association with the key of 4_0. As described above, the output addition processor 132 completes the hash table 400 for the DFG 302.

The output integration processor 133 acquires the DFG 302 and the hash table 400 of FIG. 3 from the output addition processor 132. Then, the output integration processor 133 specifies 4_0 as a key having a plurality of values from the hash table 400. Then, the output integration processor 133 acquires 5_0, 6_0, and 7_0 from the hash table 400 as values corresponding to the key of 4_0.

Next, for the output data 5_0 corresponding to value of 5_0, the output integration processor 133 specifies the output data y_β used for the calculation of the output data 5_0 as output data 1_4 from the DFG 302. Further, the output integration processor 133 specifies, from the DFG 302, the output data y_β used for the calculation of the output data 6_0 for the output data 6_0 corresponding to value of 6_0 as the output data 2_2. Further, the output integration processor 133 specifies the output data y_β used for the calculation of the output data 4_0 as the output data 3_1 for the output data 7_0 corresponding to value of 7_0 from the DFG 302.

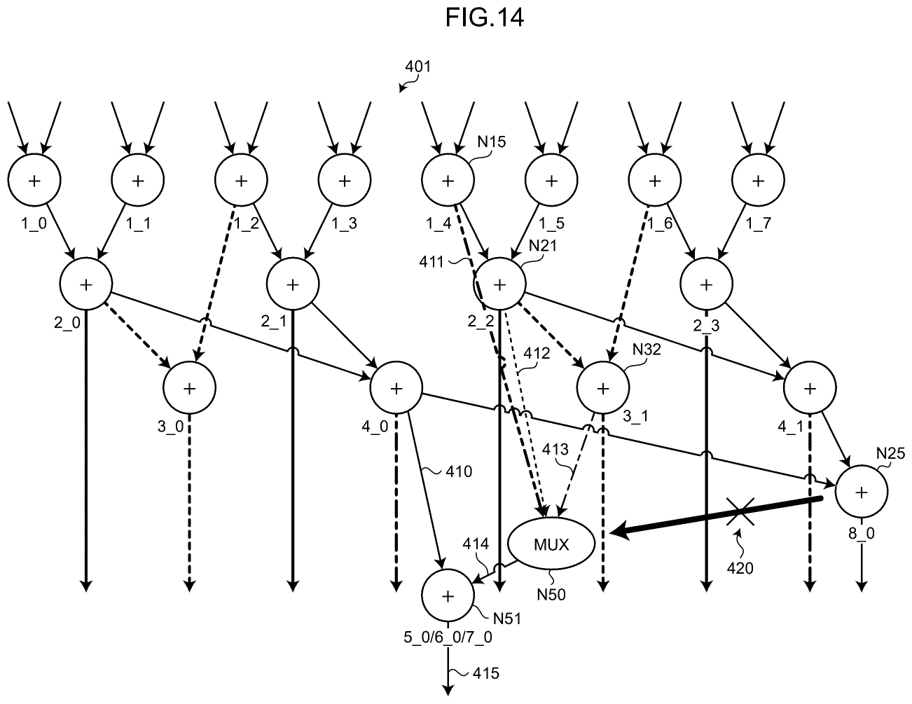

FIG. 14 is a diagram illustrating a DFG obtained by integrating outputs in a case where the loop unrolling factor is eight. Next, as illustrated in FIG. 14, the output integration processor 133 generates a multiplexer N50 that collectively receives an output 411 of the output data 5_0, an output 412 of the output data 6_0, and an output 413 of the output data 7_0 in the DFG 302. Output integration processor 133 don't integrate the output 420 of node N25, whose the loop count of the added output is the power of two, into multiplexer N50.

Further, the output integration processor 133 combines the node N33 to which the output data 5_0 has been input, the node N34 to which the output data 6_0 has been input, and the node N35 to which the output data 7_0 has been input into one node N51. Next, the output integration processor 133 connects an output 410 of the output data 4_0 from the node N23 to the node N51. In addition, the output integration processor 133 connects an output 414 of the multiplexer N50 to the node N51. Then, the output integration processor 133 uses an output 415 of the node N51 as an output of the DFG. In this case, at the output 415 of the node N51, any one of the output data 5_0, 6_0, and 7_0 is output according to the loop count.

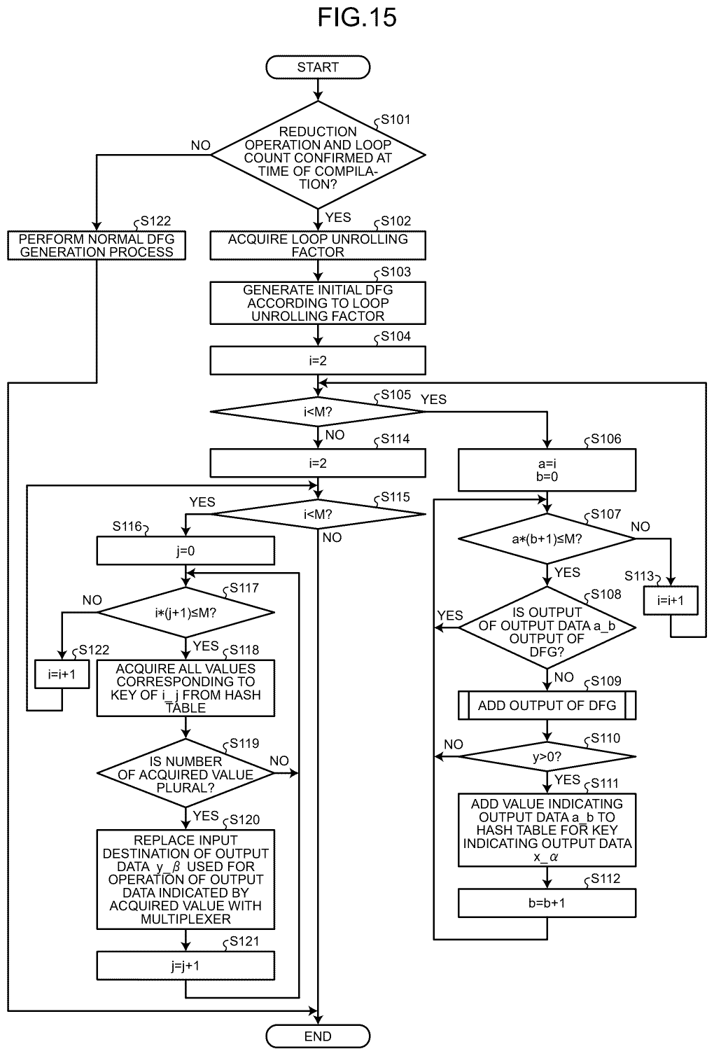

FIG. 15 is a flowchart of a DFG generation process according to the second embodiment. Next, a flow of the DFG generation process by the DFG generation device 100 according to the second embodiment will be described with reference to FIG. 15.

The general management unit 101 determines whether the operation for generating the DFG is a reduction operation and an operation for which the loop count is confirmed at the time of compilation (Step S101). In the case where the operation is not a reduction operation and an operation for which the loop count is confirmed at the time of compilation (Step S101: No), the other DFG generation unit 102 executes a normal DFG generation process for the operation acquired from the general management unit 101 (Step S122).

On the other hand, in a case where the operation if a reduction operation and an operation for which the loop count is confirmed at the time of compilation (Step S101: Yes), the initial DFG generation unit 131 acquires the loop unrolling factor together with the calculation for stopping the DFG from the general management unit 101 (Step S102).

Next, the initial DFG generation unit 131 generates an initial DFG according to the designated loop unrolling factor (Step S103). The initial DFG generation unit 131 generates and outputs the initial DFG to the output addition processor 132.

The output addition processor 132 sets i representing the loop count as i=2 (Step S104).

Next, the output addition processor 132 determines whether i is less M which is the loop unrolling factor (Step S105).

In a case where i is less M (Step S105: Yes), the output addition processor 132 sets a, which is the number of operation input data when the output data is represented by the number of pieces of operation input data and the iteration number, as a=i. Further, the output addition processor 132 sets b, which is the iteration number, as b=0 (Step S106).

Next, the output addition processor 132 determines whether a*(b+1) is equal to or less than M which is the loop unrolling factor (Step S107).

If a*(b+1) is equal to or less than M (Step S107: Yes), the output addition processor 132 determines whether the output data a_b is output data of the initial DFG (Step S108). In a case where the output data a_b is output data output from the initial DFG (Step S108: Yes), the output addition processor 132 returns to Step S107.

On the other hand, in a case where the output data a_b is not the output data output from the initial DFG (Step S108: No), the output addition processor 132 executes processing of adding the output of the DFG (Step S109). The processing illustrated in the flow of FIG. 11 corresponds to an example of the processing executed in Step S109.

The output addition processor 132 determines whether or not y is greater than zero (Step S110). In a case where y is zero (Step S110: No), the output addition processor 132 returns to Step S107.

On the other hand, in a case where y is larger than zero (Step S110: Yes), the output addition processor 132 adds value indicating the output data a_b to the hash table 400 for key indicating the output data x_α ((Step S111).

Next, the output addition processor 132 increments b by one (Step S112). Thereafter, the output addition processor 132 returns to Step S107.

On the other hand, in a case where a*(b+1) is larger than M (Step S107: No), the output addition processor 132 increments i by one (Step S113). Thereafter, the output addition processor 132 returns to Step S105.

On the other hand, in a case where i is equal to or larger than M (Step S105: No), the output addition processor 132 sets as i=2 (Step S114).

Next, the output addition processor 132 determines whether i is less than M which is the loop unrolling factor (Step S115).

In a case where i is less than M (Step S115: Yes), the output addition processor 132 sets a key to be examined as i_j, and sets as j=0 (Step S116).

Next, the output addition processor 132 determines whether i*(j+1) is equal to or less than M which is the loop unrolling factor (Step S117).

In a case where i*(j+1) is equal to or less than M (Step S117: Yes), the output addition processor 132 acquires all values corresponding to the key of i_j from the hash table 400 (Step S118).

Next, the output addition processor 132 determines whether the number of acquired values is plural (Step S119). In a case where the number of acquired values is one (Step S119: No), the output addition processor 132 returns to Step S117.

On the other hand, in a case where the number of acquired values is plural (Step S119: Yes), the output addition processor 132 replaces the input destination of the output data y_β used for the operation of the output data indicated by the acquired value with the multiplexer (Step S120). At this time, the output addition processor 132 combines the original output destination nodes of the output data y_β used for the operation of the output data indicated by the acquired value into one node, and connects the output data x_α used for the operation of the output data indicated by the acquired value and the output of the multiplexer to the node. Further, the output addition processor 132 sets outputs from the combined nodes as an output of the DFG.

Thereafter, the output addition processor 132 increments j by one (Step S121), and returns to Step S117.

On the other hand, in a case where i*(j+1) is greater than M (Step S117: No), the output addition processor 132 increments i by one (Step S122), and returns to Step S115.

On the other hand, in a case where i is greater than M (Step S115: No), the output addition processor 132 ends the DFG generation process.

As described above, the DFG generation device according to the present embodiment adds, to the initial DFG, the output of the operation result in each case of the loop count equal to or less than the loop count of the operation performed in the initial DFG, and further combines the operations that are different in the loop count and are not used at the same time into one operation.

As a result, the number of PEs to be mapped can be reduced, and the PEs can be effectively used. In addition, the output data stored in the local memory of the CGRA can be reduced, and the utilization efficiency of the operation resource can be improved. In addition, it is possible to avoid exhaustion of the memory size and the memory bandwidth.

In one aspect, the present invention can improve utilization efficiency of operation resources.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus that generates an operation configuration including functional units to be used, a connection path between the functional units, and an output path of an operation result, for a reduction operation in which a predetermined operation is repeatedly performed on two pieces of data to obtain the operation result based on a plurality of pieces of operation input data including sets of two pieces of data, the information processing apparatus comprising:
a memory; and
a processor coupled to the memory and configured to:
generate an initial operation configuration based on a loop unrolling factor that is a number of the functional units that perform the predetermined operation with the operation input data as a direct input; and
generate a first operation configuration by adding an output path of an operation result for a different degree of parallelism in a case where the predetermined operation is repeated with a predetermined degree of parallelism to the generated initial operation configuration.

2. The information processing apparatus according to claim 1, wherein the processor is further configured to, generate, as the initial operation configuration, an operation configuration for a case where the operation input data is input to the number of functional units corresponding to the loop unrolling factor to execute the reduction operation and a case where the predetermined operation is repeated with a degree of parallelism of one.

3. The information processing apparatus according to claim 2, wherein the processor is further configured to, add an output path for each case where a degree of parallelism of the predetermined operation is equal to or greater than two and equal to or less than the loop unrolling factor.

4. The information processing apparatus according to claim 1, wherein the processor is further configured to, specify two pieces of data used for the predetermined operation for calculating an operation result for a different degree of parallelism based on a number of the pieces of operation input data used for obtaining the operation result by repeating the predetermined operation with a predetermined degree of parallelism, and add an output path based on the specified two pieces of data.

5. The information processing apparatus according to claim 1, wherein the processor is further configured to, generate a second operation configuration by combining some of the output paths added by the output addition processor into one in the generated first operation configuration.

6. An information processing method by an information processing apparatus that generates an operation configuration including functional units to be used, a connection path between the functional units, and an output path of an operation result, for a reduction operation in which a predetermined operation is repeatedly performed on two pieces of data to obtain the operation result based on a plurality of pieces of operation input data including sets of two pieces of data, the information processing method comprising:
generating an initial operation configuration based on a loop unrolling factor that is a number of the functional units that perform the predetermined operation with the operation input data as a direct input; and
generating a first operation configuration by adding an output path of an operation result for a different degree of parallelism in a case where the predetermined operation is repeated with a predetermined degree of parallelism to the generated initial operation configuration, by a processor.
